(19) United States
(12) Patent Application Publication
(10) Pub. No.: US 2009/0116922 A1
(43) Pub. Date: May 7, 2009

(54) Device and Method for Deburring Grooves and Edges

(75) Inventor: Rainer Hertkorn, Oberteuringen (DE)

Correspondence Address: DARBY & DARBY P.C., P.O. BOX 770, Church Street Station, New York, NY, 10008-0770, US

(73) Assignee: ZF FRIEDRICHSHAFEN AG, Friedrichshafen (DE)

(21) Appl. No.: 11/989,682

(22) PCT Filed: Jul. 4, 2006
(86) PCT No.: PCT/EP2006/006469

§ 371 Date: Jan. 28, 2008

(30) Foreign Application Priority Data
Jul. 28, 2005 (DE) 10 2005 035 290.1

(51) Int. Cl. B23C 3/12; B23D 79/02; B24B 19/02

(52) U.S. Cl. 409/140; 451/177

(57) ABSTRACT

A device for deburring at least one of a groove and an edge of a workpiece includes a shaft, a receptacle connected to the shaft, a tool held in the receptacle, and a swivel drive configured to pneumatically and/or hydraulically press the receptacle with the tool against a burr of the groove or against the edge of the workpiece. The tool is configured to be actively lifted from the groove or edge of the workpiece.

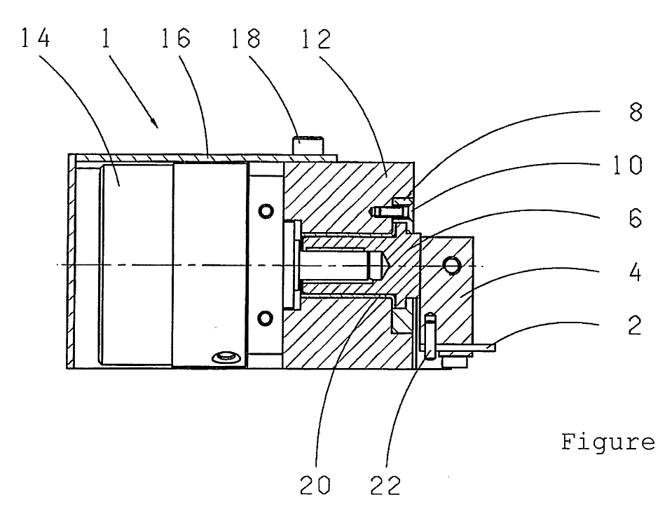

The invention relates to a device and to a method for deburring grooves and edges in the manner defined in greater depth in the generic part of claim 1.

German Preliminary Published Application DE-OS 39 14 563 discloses a tool for removing excess material that adheres to workpieces in the form of burrs, molded matter or the like. The tool is configured to be disk-shaped or roller-shaped with tooth-like elements elastically mounted as active working elements.

Owing to its geometry, the tool known from the state of the art for removing excess material is not suitable for use for small components, grooves and workpiece edges.

The contact pressure of the tool can only be set to a greatly limited extent or not at all in the case of the tool known from the state of the art. Moreover, it is not possible to control the tools and to integrate the tools into fully automatic processing sequences. Moreover, there is no possibility to request a basic setting of the tool, as a result of which complicated and demanding setting procedures have to be carried out. The tool to be used according to the state of the art cannot be used universally and, in each case, has to be adapted individually to the workpiece that is to be deburred. Consequently, many different tools have to be provided and monitored, which calls for a considerable effort in terms of inventory and checking procedures.

The present invention is based on the object of providing a device as well as a method for deburring grooves and edges, which can be used universally and can be integrated into fully automatic processing sequences.

The object upon which the invention is based is achieved by a device of the generic type that also has the characterizing features of the main claim as well as by an appertaining method for deburring grooves and edges.

Thanks to the use of a tool that is held in a tool receptacle and that can be pneumatically and/or hydraulically pressed by means of a swivel drive against the burr of the groove of the workpiece and that is actively lifted from the workpiece again, it is possible to process a plurality of different geometries of grooves in workpieces using just one tool that can be incorporated into fully automatic sequences. The tool is preferably configured to be finger-shaped in the form of a groove chisel.

The solution according to the invention also makes it possible to control the tool via contact-free sensors with which the workpiece is monitored for wear and/or damage. The tool can be pressed by the swivel drive against the groove to be deburred or against the edge of the workpiece and can be actively lifted again. The swivel drive can be actuated by a pressure reducer, as a result of which the contact pressure of the tool on the workpiece is regulated. The swivel drive is advantageously configured as a rotating cylinder that can easily be integrated, thanks to its compact design. Due to the space-saving design of the device according to the invention, it is possible for the tool to describe a large swiveling range, which allows a great deal of freedom in the placement and withdrawal of the workpiece. Moreover, it is also possible to deburr grooves having beveled edges.

The present invention of a device for deburring grooves is explained in greater depth with reference to an embodiment shown in the FIGURE.

The single FIGURE shows a device 1 according to the invention for deburring grooves and edges with a tool 2, here in the form of a groove chisel, which is held in a receptacle 4. The receptacle 4 is connected to a shaft 6. A cover is non-rotatably connected to a flange via fastening elements 10. A swivel drive 14 is non-rotatably connected to the flange 12. A covering 16 is connected to the flange 12 by means of fastening elements 18. A bearing bush 20 is situated between the flange 12 and the shaft 6. A pin 22 secures the tools 2 in the receptacle 4.

### LIST OF REFERENCE NUMERALS

1 device
2 tool
4 receptacle
6 shaft
8 cover
10 fastening element
12 flange
14 swivel drive
16 covering
18 fastening element
20 bearing bush
22 pin

1-5. (canceled)

6: A device for deburring at least one of a groove and an edge of a workpiece, the device comprising:
a shaft;
a receptacle connected to the shaft;
a tool held in the receptacle;
a swivel drive configured to pneumatically and/or hydraulically press the receptacle with the tool against a burr of the groove or against the edge of the workpiece, wherein the tool is configured to be actively lifted from the groove or edge of the workpiece after the deburring procedure.

7: The device as recited in claim 6, further comprising a pressure reducer actuating the swivel drive so as to regulate a contact pressure of the tool on the workpiece.

8: The device as recited in claim 6, wherein the tool is one of a milling tool and a grinding tool.

9: The device as recited in claim 6, further comprising a plurality of contact-free sensors integrated into the device an configured to monitor the tool for at least one of wear and damage.

10: A method for deburring at least one of a groove and an edge of a workpiece, the method comprising:
providing a tool held in a receptacle connected to a shaft;
pressing the receptacle using a swivel drive against a burr of the groove or against the edge of the workpiece;
actively lifting the tool from the groove or edge.
